(19) United States
(12) Patent Application Publication
(10) Pub. No.: US 2005/0150430 A1
(43) Pub. Date: Jul. 14, 2005

(54) Refractory material based on polycrystalline alumina

(76) Inventors: Florent Bourlier, Issy Les Moulineaux (FR); Frederic Roquefeuil, Marseille (FR)

Correspondence Address: DENNISON, SCHULTZ, DOUGHERTY & MACDONALD, 1727 KING STREET, SUITE 105, ALEXANDRIA, VA, 22314, US

(21) Appl. No.: 10/508,692

(22) PCT Filed: Apr. 3, 2003
(86) PCT No.: PCT/FR03/01048

(30) Foreign Application Priority Data
Apr. 8, 2002 (FR) 02/04356

(51) Int. Cl. C04B 16/08; C04B 35/03

(52) U.S. Cl. 106/816; 106/672; 501/127; 501/94

(57) ABSTRACT

The invention concerns a refactory material based on corundum treated by electrofusion consisting of beads of diameter ranging between 50 μm and 5 mm, having a total pore ratio ranging between 10 and 50 % of the volume of the beads, the sealed porosity representing from 80 to 98% of the total porosity. The inventive material is in particular designed for spray-applied refractory concrete.

### TECHNICAL FIELD OF THE INVENTION

The invention relates to alumina-based refractories intended particularly for lining a wide variety of furnaces, and lining of casting ladles designed to contain melted materials.

### STATE OF THE ART

The use of alumina-based refractories is very widespread, for example in the form of electrically melted white corundum, or in the form of alumina calcined at high temperature in a rotary furnace. Preparation of an alumina suitable for a refractory application is still a difficult operation. The raw material is composed essentially of bauxites, natural alumina hydrates from which alumina is extracted by alkaline digestion to form a sodium aluminate from which alumina hydrate is subsequently precipitated, which then results in alumina by calcination.

It is known that aluminium hydroxide is calcined by carrying out a series of complex transformations one after the other up to high temperatures. Thus, an appropriate way for obtaining a stable material is to calcine the product at very high temperature. Such a choice was made for example for obtaining the so-called tabular alumina.

Since a very high temperature is necessary, it may be preferred to continue until melting; in such a case, an electrically melted corundum is prepared that is also well known as a frequently used refractory material.

In both cases, the size grading of the alumina must be suitable. For tabular alumina, the material is balled before calcination, while for electrically melted corundum the material is crushed and screened.

Direct shaping attempts have been made in the past. For example, patent U.S. Pat. No. 1,871,793 by Alcoa in 1932 that describes atomisation of electrically melted alumina to transform it into hollow spheres with a diameter of less than 5 mm, and a wall thickness of less than 250 μm. The product obtained is a reduction-grade alumina that will be used as a raw material for manufacturing of aluminium; its use as a refractory is not envisaged. It is probable that this material composed of balls resembling mini table tennis balls will have a fairly low mechanical strength.

Furthermore, atomised electrically melted corundum is routinely made to obtain a material in the form of solid balls that are then used for manufacturing of abrasives.

### PURPOSE OF THE INVENTION

The purpose of this invention is to supply an alumina-based refractory material with good thermal stability and good compressive strength, useable particularly in the form of a refractory concrete to be sprayed, also called “shotcrete”.

The subject of the invention is a refractory material based on electrically melted corundum composed of balls with a diameter of between 50 μm and 5 mm, with a total void ratio between about 10 and 50% of the volume of the balls, with closed pores accounting for between 80 and 98% of the pore volume.

### DESCRIPTION OF THE INVENTION

As a result of different manufacturing incidents that occurred during the manufacture of atomised electrically melted corundum balls for abrasives, the applicant observed that it was possible to obtain products intermediate between solid balls and hollow balls. The material is always in the form of balls, but the structure of these balls is the structure of a sponge that is more or less dense; while the hollow ball comprises a single spherical macro-pores well centred in the ball, the material obtained has many arbitrarily-shaped micro-pores distributed fairly uniformly. After many tests designed to reduce the apparent porosity (open pores) of these balls, the applicant has successfully defined operating conditions necessary to obtain balls in which very few pores open onto the surface.

The compressive strength of the material according to the invention is higher than a hollow ball, while its thermal conductivity remains low due to the presence of pores.

It is in the form of practically spherical balls with an outside diameter between 50 μm and 5 mm, and preferably between 0.5 mm and 2 mm. These balls have mostly closed pores, their volume being equal to between 10 and 50% of the total volume of the balls, and preferably between 20 and 30%. The open pores, corresponding to pores opening up on the surface of the ball, measured by pycnometry with water at atmospheric pressure, is between 2 and 20%.

The material from which these balls are made is composed of polycrystalline alumina formed from crystallites smaller than 50 μm. This structure is particularly stable up to about 1500° C. It can be verified by examining the material with an electronic microscope after annealing to 1500° C., and this examination shows that there are no changes that modify the structure of the product.

The compressive strength of the balls according to the invention is typically between 150 and 300 g, compared with 30 to 40 g for hollow balls according to prior art, with a thermal conductivity of the bulk material within the temperature range 200° C.-1200° C. equal to 0.5 to 0.8 Wm^{-1o}K⁻¹, compared with 0.4 to 0.6 Wm^{-1o}K⁻¹ for hollow balls according to prior art.

In particular, this material can be used to prepare easy to use shotcrete, due to the spherical shape of the particles from which it is made.

The process for manufacturing products according to the invention consists of casting melted white or brown corundum in a solid stream, onto a horizontal air film containing atomised water, said casting causing atomisation of the product. The optimum parameters for obtaining products according to the invention are as follows:
air pressure on the film: 0.05 to 0.1 MPa;
film width: 2 mm per kg of liquid corundum to be treated in one minute;
film thickness: a few millimetres;
ratio between water flow and melted corundum flow: 0.2 to 1.5 litres of water per kg of melted corundum.

### EXAMPLES

### Example 1

A sufficient quantity of Bayer alumina was melted in a 2 MW arc furnace to give an approximately 2 tonne reserve of electrically melted white corundum. This reserve was used for continuous casting of a regular stream of liquid corundum for 10 minutes at a rate of 100 kg per minute, directly on a mixed air and water film.

This film was generated by an orifice with a 240 mm wide and 6 mm high rectangular section located in a vertical plane, and supplied by an air source maintaining a pressure of 0.09 MPa on the orifice under permanent conditions. 22 kg of water per minute was injected into the air stream.

After casting, the corundum was retrieved in a pit on the downstream side of the installation, and its size distribution was as follows:
fraction <0.5 mm: 15%;
fraction >2 mm: 20%;
fraction >5 mm: 3%.

The void ratio of the product was 28%, including 1.3% of open pores.

The compressive strength of the balls was 260 g.

### Example 2

A refractory concrete was prepared from a mix of dry products with the following composition by weight:
brown corundum with size grading between 2 and 5 mm: 23%;
brown corundum with size grading between 0.2 and 2 mm: 37%;
brown corundum with size grading <0.2 mm: 24%;
amorphous micro-silica with balls smaller than 20 μm: 5%;
P622B alumina with low soda content made by Aluminium Pechiney: 6%;
Secar 80 cement with high alumina content made by Lafarge Aluminates: 5%.

The following products were added to the mix, for mixing and for placement:
sodium metaphosphate: 0.2%;
Darvan C® ammonium polymethacrylate made by the Polyplastic company: 0.3%;
water: 6%.

The result after drying and baking was a refractory concrete with a density of 3.0 kg/dm³.

Its thermal conductivity measured at 600° C. was 5.5 W^{o}m⁻¹C⁻¹, and its compressive strength was estimated at 110 MPa.

### Example 3

A refractory concrete was prepared starting from a mix of dry products with the following composition by weight:
balls according to the invention with a size of between 2 and 5 mm: 15.4%;
balls according to the invention with a size of between 0.2 and 2 mm: 37%;
brown corundum size <0.2 mm: 30%;
amorphous micro-silica made of balls size <20 μm: 5.5%;
P622B alumina: 6.6%;
Secar 80 cement: 5.5%.

The following products were added for mixing and placement:
sodium metaphosphate: 0.2%;
Darvan C®: 0.3%;
water: 8%.

The result after drying and baking was a refractory concrete with a density of 2.5 kg/dm³.

Its thermal conductivity measured at 600° C. was 2.7 W^{o}m⁻¹C⁻¹, and its compressive strength was more than 100 MPa. This lining was found to be perfectly stable when placed on the walls of a furnace operating at 1450° C.

1. Refractory material based on electrically melted corundum comprising balls with a diameter of between 50 μm and 5 mm, with a total void ratio between about 10 and 50% of the volume of the balls, with closed pores accounting for between 80 and 98% of the pore volume.

2. Refractory material according to claim 1, characterised in that the total pore volume is between 20 and 30% of the volume of the balls.

3. Refractory material according to claim 1, comprising polycrystalline alumina formed from crystallites smaller than 50 μm.

4. Refractory material according to claim 1, characterised in that the compressive strength of the balls from which it is made is between 150 and 300 g.

5. Refractory material according to claim 1, characterised in that the thermal conductivity of the bulk material is between 0.5 to 0.8 Wm^{<1o}K⁻¹.

6. Refractory material according to claim 1, characterised in that there is no crystalline transformation up to 1500° C.

7. Refractory material according to claim 1, characterised in that the average diameter of the balls is between 0.5 and 2 mm.

8-9. (canceled)

10. A refractory concrete comprising a material according to claim 1.

11. A refractory concrete according to claim 10, placed by spraying.
